(19) United States
(12) Patent Application Publication
(10) Pub. No.: US 2020/0240576 A1
(43) Pub. Date: Jul. 30, 2020

(54) ORTHOGONAL TWO AXIS KINEMATIC TRANSLATION STAGE

(71) Applicant: Andrew Norman Erickson, Santa Barbara, CA (US)

(72) Inventors: Andrew Norman Erickson, Santa Barbara, CA (US); Kyle Alfred Hofstatter, Santa Barbara, CA (US)

(21) Appl. No.: 16/777,373

(22) Filed: Jan. 30, 2020

Related U.S. Application Data
(60) Provisional application No. 62/799,038, filed on Jan. 30, 2019.

(51) Int. Cl. F16M 11/20; F16C 29/02

(52) U.S. Cl. CPC F16M 11/2085; F16M 11/2092; F16C 29/02

(57) ABSTRACT

A positioning stage employs a constraining plate having three contact elements fixed therein, each contact element protruding from the constraining plate providing a lower engagement surface and an upper engagement surface. A first plate has at least two slots aligned for a first axis of translation. The slots are engaged by the lower engagement surfaces the contact elements. A second plate has at least two slots aligned for a second axis of translation. The slots are engaged by the upper engagement surface of two of the contact elements, thereby providing two axes of motion for positioning.

### REFERENCES TO RELATED APPLICATIONS

This application claims priority of U.S. provisional application Ser. No. 62/799,038 filed on Jan. 30, 2019, entitled ORTHOGONAL TWO AXIS KINEMATIC TRANSLATION STAGE and having a common assignee with the present application, the disclosure of which is incorporated herein by reference.

### BACKGROUND INFORMATION

### Field

Embodiments of the disclosure relate generally to the field of small, high precision translation devices where a one plate or structure is translated with respect to another plate.

### Background

In determining the position and orientation of one structure relative to another structure, it is typical to guide and constrain the body's motion degrees of freedom. It is typical in the art to describe free body movement with 6 axis of freedom X, Y, Z, θ₁, θ₂, θ₃. Although the naming conventions and coordinate systems vary wildly and are chosen as convenience to describe different types of motion with rotation, translation, and tilt being typical.

McCabe, et. al. disclose a mounting system using kinematics arranged in radial slots as a base for fine metrology tools and show multiple exemplary types of defining the contact points of the kinematic surfaces using balls and cones interacting with pins, grooves, and bevels in U.S. Pat. No. 4,763,420A. Such designs for mounting, constraining, and positioning are well known in the art. In particular, McCabe is a good reference for understanding the manner in which this stage will not distort under thermal expansion of the base while maintaining complete secure mounting.

Kinematic mounting is described at length in an interesting patent disclosure by Kemeny in U.S. Pat. No. 8,413,948. The prior art description includes types of kinematic mounts and provides roughly complete understanding of degrees of freedom. Further disclosed is a novel method of providing a shock resistant mounting embodiment providing two opposing faces containing the typical kinematic surfaces of groove, cone, flat as well as triple radial groove types. The elements are used to provide a mounting which fixes the opposing plates in all six degrees of freedom in translation and rotation. Further disclosed is an intervening plate between the mounting faces with bores for the balls.

Frankly speaking, the art of positioning and constraining body motion has been in development for thousands of years and it is well beyond the scope of this disclosure to discuss it or provide basic refences! Such motion might be Cylindrical, Polar, or Cartesian in design depending upon the type of motion for example a mill stone, circus ride, or a metal milling machine work piece stage. Nevertheless, in precision equipment positioning stages, it is standard to achieve controlled motion/positioning by stacking orthogonal motion stages where such stages are linear guide bearings, rotation bearings, or tilt stages. Linde discloses use of a ball bearing cage in U.S. Pat. No. 1,712,222. The cage maintains separation and placement of the bearings while allowing the balls to roll. Bajulaz discloses a ball bearing raceway allowing reciprocation and continuous linear guidance in U.S. Pat. No. 2,599,969 while McVey discloses a similar reciprocating arrangement for the bearings in U.S. Pat. No. 2,672,379. In U.S. Pat. No. 3,897,119 McMurtrie discloses a linear slide bearing using rollers in place of balls as bearings and in U.S. Pat. No. 4,215,904 Teramachi discloses a crossed roller bearing cage for maintaining the spacing of bearings without interfering in their rolling motion among other things. The types of stages used in precision equipment are widely available from a host of well-known vendors. A very typical configuration would be motion of a top surface relative to a bottom surface with ball bearings rolling between those surfaces in a guide. Generally, the rolling bearings are compressed between two guide rail pieces and two or more opposing sets of rails are used for each axis. For the purposes of this disclosure, it should be understood that the design elements of mounting and loading the bearings adds bulk and complexity to the design. Nevertheless, millions of machines use this type of bearing are in use in diverse application.

While stacking positioning stages to achieve controlled motion separates the motions into individual orthogonal elements it also results in non-ideal effects. For best understanding, the term primary is used to refer to the stage attached to a fixed reference and a subsequent stage with its fixed reference attached to the moving portion of the primary stage being the secondary stage. Prior stages are closer to the overall fixed reference and subsequent stages are closer to the moving payload. Each stage has a finite size and motion range as well as properties such as a mass, thickness, trueness of motion, and mechanical stiffness with each successive element suffering from the errors introduced by the previous stage. Specifically, it is an undesirable if one stage has out of plane motion which is introduced into the motion of the subsequent stages. Furthermore, deformation of one stage under static or dynamic loads, also create motions introduced into all subsequent stage motions. Also, the mass of each stage is added in sequence to the effective payload carried by all previous stages increasing the deformations. In a multiple degree of motion design, the errors introduced in the final motion, the stacked mass and inertial of each subsequent stage and the combined mechanical compliance of the combination must be accounted for in the final motion and positioning of the actuated payload. Lastly the mechanical stiffness of the payload's positioning is a superposition of all the positioning stages. The mechanical size of the stack will make increase torques between moving payload and fixed reference. Generally, for high precision, reduction of physical dimension, mass, and compliance in motion and number of positioning stages is desirable.

Gunderson discloses a higher accuracy compact orthogonal motion stage with coupled axis in U.S. Pat. No. 6,781,753. The disclosure of a frame and semi-kinematic camming to permit orthogonal tip-tilt and lift while compressing the elements to minimum size also compels disclosure in the background describing the benefits or reducing mass and size of stages.

George discloses a a precision microscope stage in U.S. Pat. No. 3,652,146. Disclosed is a stage for moving 3 coordinate axis (X, Y & Z) where the planar axis of X and Y are driven externally with worm gears and cams and the inner sample holding shuttle is constrained in a Y frame within an X frame. The resulting system is substantially thin as is desirable for microscope stages. The XY shuttle is supported by a Z mechanism used for focus combining control of all three axis into one set of stacked stages which is exemplary of this type of design for moving a sample relative to a microscope. The mechanical motion and positioning of this type of device is a superposition of any weakness in the precision of each stage in the stack.

Bardocz discloses magnetically held kinematic ball stages in U.S. Pat. No. 3,720,849 in which he shows a series of three separate motions stacked one each other will rolling balls within kinematic bearing guides for X, Y, and rotational motion clamped together with magnets.

In prior art common in the field of micrometer or nanometer positioning and arrangements have been provided of what is called a kinematic slide with balls fixed in one structure and a second structure constrained by an arrangement of grooves and/or flats to slide in a linear fashion. The balls in these arrangements do not roll but rather the moving, second structure slides against the balls. Ordinarily, the balls and slides should be dissimilar materials to avoid sticking between the point contacts. Common material choices would be sapphire or ruby for the balls and hardened steel for the slides although other choices can be made.

Scire discloses a planar biaxial micropositioning stage in U.S. Pat. No. 4,506,154 where a set of flexures and piezo movers will generate two directions of orthogonal motion in a plane within a monolithic part. While such stages are in wide spread use in micro or nano positioning today, they can only move small ranges and generally carry small loads.

### REFERENCES CITED

U.S. Pat. No. 4,763,420 McCabe et. al.
U.S. Pat. No. 8,413,948 Kemeny
U.S. Pat. No. 6,781,753 Gunderson
U.S. Pat. No. 3,652,146 George
U.S. Pat. No. 1,712,222 Linde
U.S. Pat. No. 2,599,969 Bajulaz
U.S. Pat. No. 2,672,379 McVey
U.S. Pat. No. 3,897,119 McMurtrie
U.S. Pat. No. 4,215,904 Teramachi
U.S. Pat. No. 4,506,154 Scire

### SUMMARY OF THE INVENTION

A positioning stage employs a constraining plate fixing at least three contact elements protruding from the constraining plate, the constraining plate fixing the contact elements both from individual rotation or motion relative to the other contact elements. A first plate has at least two slots aligned for a first axis of translation A second plate has at least two slots aligned for a second axis of translation, the first and second plate's slots engaging the upper and lower engagement surfaces in kinematic sliding motion of achieving two axes motion.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1A is a rotated exploded view of stage elements of first and second plates and ball securing plate to achieve two directions of orthogonal translation;

FIG. 1B is an upper pictorial representation of the assembled stage elements;

FIG. 2A is a side view of the stage elements to provide goniometric and translation motion;

FIG. 2B is a side view of a first configuration for a ball slot interface;

FIG. 2C is a side view of a second configuration for a ball slot interface;

FIG. 3A is a side view of a ball and slot configuration with sharp slot corners prior to working;

FIG. 3B is a side view of a ball and slot configuration with chamfered slot corners after working;

FIG. 3C is an upper pictorial representation of an example ball and slot configuration;

FIG. 4A is a side view demonstrating a ball which is fixed in a constraining plate but which is misaligned relative to the guide slot edge;

FIG. 4B is a side view showing the effect of the load and yielding resulting in a heavier chamfer on an initial contact edge and a lighter chamfer on the opposite edge;

FIG. 5 is a top view of alternative embodiment in which rotation is combined with one axis of translation; and,

FIG. 6 is a top view of a second alternative embodiment providing goniometric motion in the top plate.

### DETAILED DESCRIPTION

Having described some limitations in the art, implementations herein provide a new stage design for positioning and orthogonal movement whereby, two sets of orthogonal motion may be combined into the same stage. Such a stage is kinematic at all points in its motion and therefore more stable and rigid than standard rolling bearing stages. The small size of such stages is enabled due to the novel construction. Furthermore, the two motions need not be simply orthogonal cartesian motions, it is also possible to construct the stage to get translation and either rotation or goniometric motion.

The present invention provides for a very low profile and extremely stable two direction translation stage. Because the bearing elements are common to both directions of motion, the stage is very low profile limited to the diameter of the bearings which would commonly be spherical balls. Furthermore, there is essentially no compliance in the stage beyond the bearings and guides themselves. In comparison to individual rail sets for motion stages of the prior art, the present invention allow great simplicity in design and reduction in cost and size.

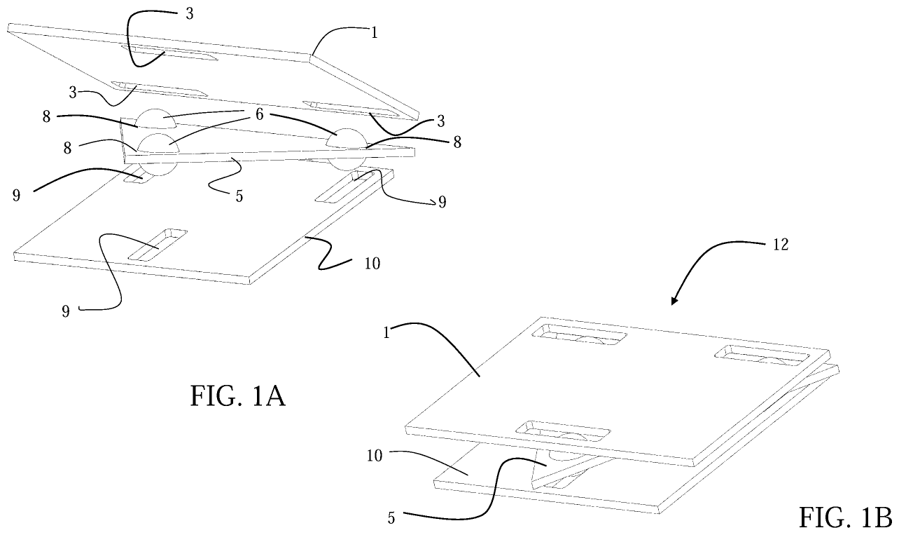

FIG. 1A shows an exploded view of the elements and their orientation in an X versus Y translation arrangement. The x plate 1 with three parallel x guides provided by slots 3. The guides are slots, spaced on the plate roughly equally and in a pattern that will align the guides to the other two plate elements. A constraining plate 5 fixes spherical ball bearings 8 as contact elements in ball mounts 6 in three positions corresponding to the positions of the x guide slots 3 on the x plate as well as y guides slots 9 in a y plate 10. The ball bearings 8 extend through the ball mounts 6 providing opposing hemispheres on opposite sides of the constraining plate 5. FIG. 1B shows the xy kinematic stage assembly 12 comprising x, y, and constraining plates and bearings shows the relative orientation of the first embodiment of the invention. This embodiment allows both X and Y cartesian motion but with no rotation allowed between the upper and lower faces. The positions of the guides, their spacing and parallelism is required for the stage to mate properly. The constraining plate is shown as being triangular in shape and the X and Y plates as rectangles only for the sake of clarity. The plates may take any shape and will generally include apertures or mounting holes as required which are not shown. A requirement of the present invention is that the bearings do not roll or move but are fixed in the constraining plate.

The assembly can be best understood as a pair of upper and lower kinematic slides. The X plate 1 and constraining plate 5 form one kinematic slide and the Y plate 10 and constraining plate 5 form an additional kinematic slide with the following properties: First, each kinematic slide is unconstrained in exactly one dimension: the cartesian X directional motion for the X plate versus constraining plate and Y motion for the Y plate versus constraining plate pair. Second, the two kinematics mounts are over constrained in that each contains two extra tangential point contract relationships between a ball and a guide edge beyond that which is required to strictly maintain all but one degree of freedom, the three balls will be unconstrained to slide along the parallel dimension.

In contrast to the prior art, the present invention provides a constraining plate to fix the lateral positions of the balls. Not allowing relative motion between the balls means that the upper and lower slides are each kinematic but using the same bearing without the addition of a redundant intervening plate with identical guides. By sacrificing rolling motion of ball or roller bearings in favor of sliding balls fixed in a constraining plate, it is possible with the present invention to allow bi-axial, kinematic motion using only one set of bearings and providing a very low profile, compact, rigid bi-axial guided motions.

Construction of the above plates can be accomplished with sheet metal using a punch die, water jet, or laser or by using a milling machine to cut slots. Furthermore, it is anticipated in this specification that silicon or other MEMS compatible materials allow construction of the parallel guides as shown in the embodiments. Photolithography, etching, and deposition are all well known in the art as methods of constructing slots or grooves. Fixation of the balls in the constraining plate can be accomplished by brazing, gluing, or press-fitting and the plates themselves may consist of a single plate or multiple laminated or fused plates. Furthermore, in the first embodiment of the present invention the balls are shown as single units although this disclosure anticipates that the bearings could be hemispherical, half round or conical structures or the like and might each be attached separately to the upper and lower surfaces of the intervening constraining plate. For the best stiffness, accuracy, and simplicity the ideal construction is a ball pressed into the middle plate whereby any load is transferred directly from the bottom guide to top guide via a rigid ball. This simple arrangement provides the least compliance in the structure.

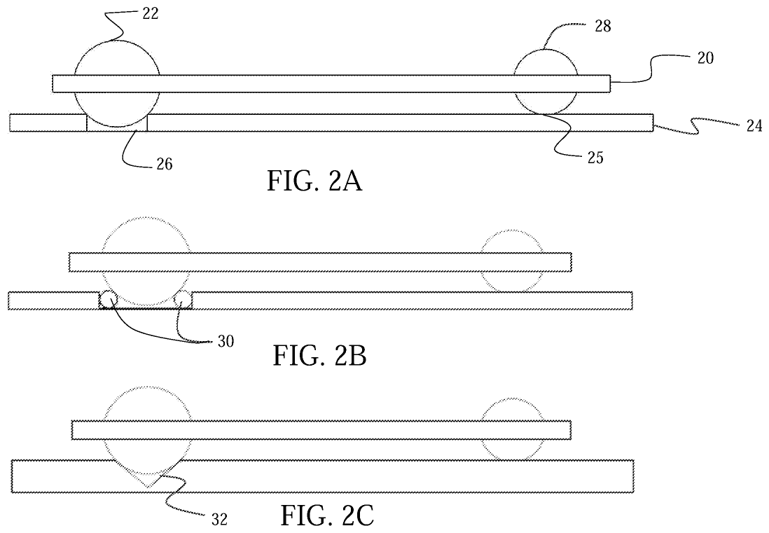

In the description above, it has been remarked that in the first embodiment, the balls are over-constrained in the pure kinematic sense. An example of a properly constrained embodiment of the invention is shown in FIG. 2A. Three balls are fixed in a modified constraining plate 20. Two large balls 22 (only one visible in the drawing with the second behind) are of the same size and engage a modified Y plate 24 in two parallel slots 26 (only one visible in the drawing) which will constrain the motions to only one axis in and out of the page and one smaller ball 28 will engage a flat face 25 to constrain rotation about the motion axis. The embodiment shown in FIGS. 1A and B can be modified in this way by removing one guide on each plate and replacing one of the balls with a correctly sized, smaller diameter ball as in FIG. 2A. The guides can also be constructed using cylindrical elements 30 laid on edge as shown in FIG. 2B and V shape faces 32 as shown in FIG. 2C. The elements of the kinematic slide can be arranged as two slots and a flat or a slot and two edges as is understood in the art of making such slides.

In constructing and testing exemplary implementations, it has been found that using balls that are significantly harder than guide material overcomes the theoretical kinematic overconstraint of six parallel, tangential connections comprised of two edges on each guide contacting 3 balls. The over constraint can be easily seen by imagining a defect in the machining tolerance resulting in a slight variation in the width of a guide. The ball would “choose” one edge to follow and lose contact with the other edge. The motion of the plates would still be constrained but the structure would undergo a torque not countered by the uncontracted side of the guide.

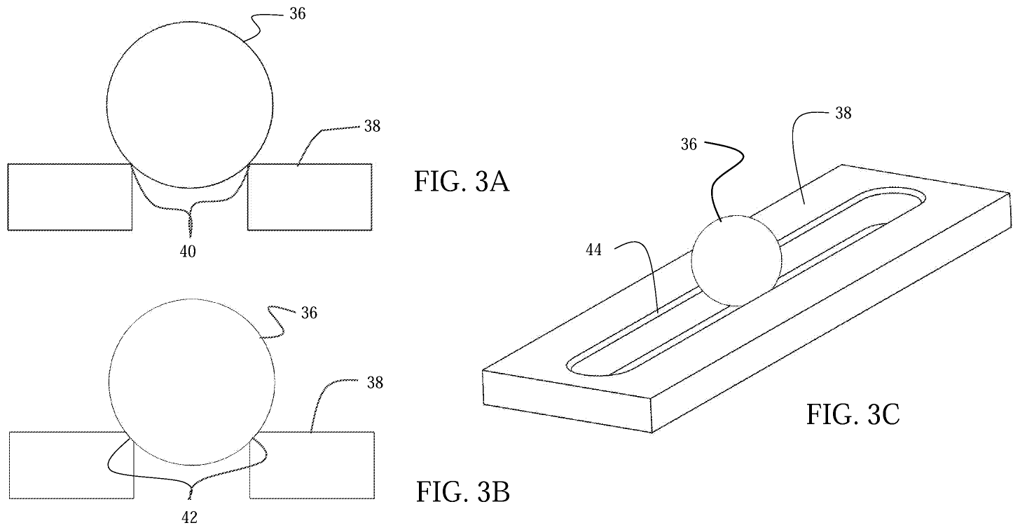

The elements of FIGS. 3A-3C show the convenient effect of using slots cut from half hardened sheet or plate steel or similar as the guide material 38 of the plates in conjunction with a contact element such as a ruby ball 36. Ruby is roughly twice as hard as steel and is preferable to a translucent Sapphire ball only because the ruby ball is red and easier to find when it rolls off a worktable. In practice either material will work well as would a hardened steel ball. The initial state is shown in FIG. 3A with the ball making point contacts on the two sharp edges of the slot 40. The initial contact area is extremely small and on the order of the multiplied roughness of the ball surface and the guide edge. FIG. 3B shows the effect of load applied between the ball and the guide. The pressure on the point contact between the harder ruby and the steel guide slot edge will be higher than the steel's deformation limit and will result in the steel edge yielding and work hardening into chamfered faces 42. The chamfer will be smooth, concave matching the ball radius, hardened and with a surface contact area large enough reducing the pressure such that it will withstand further yielding. The convenient process of the guide edge yielding to a harder ball material results in a seated guide 44 as shown in FIG. 3C.

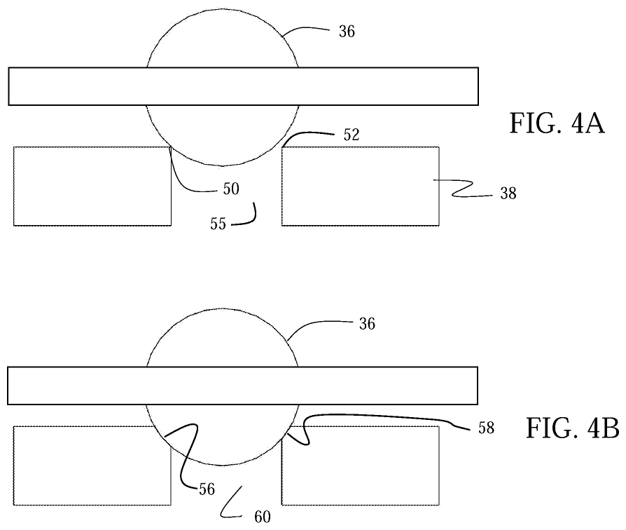

The happy process of yielding and work hardening the guide slot to a chamfered face also removes any effect from the kinematic overconstraint and this process is shown in FIGS. 4a and 4B. FIG. 4A depicts a ball which is fixed in the constraining plate 5 but which is misaligned relative to the guide slot edge. The result will be a contact point 50 and a non-contact point 52 between the ball and the misaligned slot 55. The misalignment can be caused by a small manufacturing tolerance error between the constraining plate's ball mount holes and the guide plate slots. In an identical fashion as described above, the contact point has almost no surface area initially and therefore is under extremely high pressure with any load applied between the ball and slot. In principle, the high pressure is generated when simply assembling and applying load to the opposing plates. FIG. 4B shows the effect of the load and yielding resulting in a heavier chamfer 56 on the initial contact side and a lighter chamfer 58 on the opposite side. The end result is a self-aligned guide slot 60.

In practice, the embodiment of FIGS. 1A-1C will work fine despite the theoretical over-constraint after the parts are exercised a few times. Furthermore, after many thousands of cycles, no additional wear after the initial working and self-alignment has been detected in exemplary implementations. The initial working can be at a higher loading than the anticipated load of typical use thereby ensuring that the chamfer face does not wear substantially. In example implementations is has been determined that the chamfer will be roughly 1-4% of the radius of the ball dependent upon the load force applied and slightly concave in shape matching the ball radius closely. The guide location and size need to be manufactured to within this tolerance. In alternative implementations more than three guides can be used because the self-alignment process will form chamfers and properly seat all the balls so long as the manufacturing tolerance is maintained below a few percent of the ball radius. Furthermore, a small amount of grease may be applied to the surface for smoothest results. Construction of self-aligned guides with softer material than the bearings is convenient with respect to the kinematic constraint and cost. If the faces are of similar or higher hardness relative to the bearing, the self-alignment process will not take place but instead the bearing will wear unless the design is properly constrained as previously described.

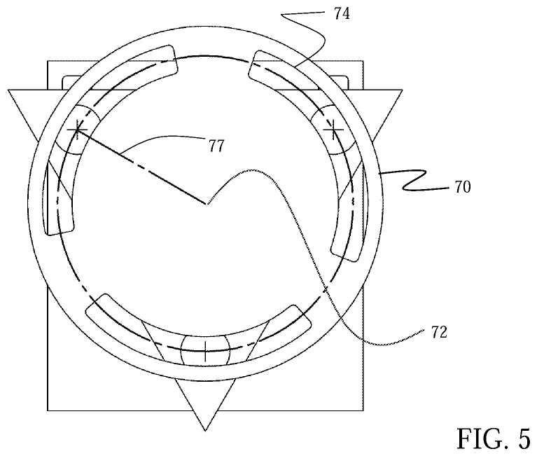

Having described both the function, construction, and use of a two axis cartesian stage of the present invention, an alternative embodiment is shown in FIG. 5 in which rotation is combined with one axis of translation. A rotation plate 70 comprises a rotation axis 72 about which three rotation guide slots 74 are formed by cutting slots of consistent width at the radius of the ball positions 77 relative to the rotation axis. The example of the drawing provides a Y axis translation on the bottom plate as in the first embodiment and the slots have been cut with roughly 100 degrees of mobility although a groove cut to only partial depth into a rotation plate could comprise a complete, single guide of 360-degree rotation.

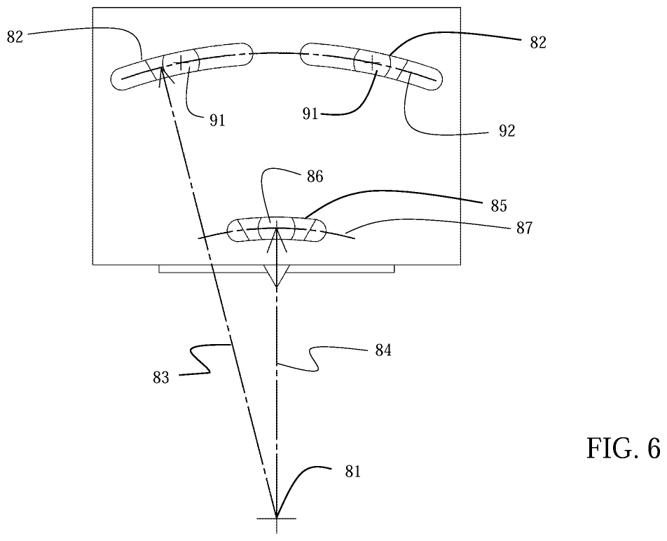

A second alternative embodiment is shown in FIG. 6 providing goniometric motion in the top plate. A goniometric plate 80 is formed by choosing a center of rotation 81 may be chosen outside of the center of the balls or even outside of the outline of the plate by choosing greater radii of curvature 83 and lesser 84 radii of curvature 83 and 84 of the outer slots 82 and inner slot 85. If the slots are formed with a common center of curvature about the center of rotation 81, the plate will be constrained to move along the inner slot over the inner ball 86 on the lesser chord 87 and the outer slots will move over the outer balls 91 along the greater chord 92. The underside plate shown in the figure is a cartesian slide but a combination with a rotation stage or different goniometric stage might be desired and can be constructed with the present invention.

The motions defined by the guides need not be monotonic, a doubly curved slot is also possible to define as would be any shape with smooth edges although a need for such a path of motion has not been identified.

Springs or magnets can be used to hold the plates in contact with the balls. Clamping the plates together is not generally viable due to the required two-dimensional motion between the upper and lower plates except in the case of rotation where a clamp can be placed at the axis. Because springs and magnets are somewhat limited in strength, the result is that the current design is preferred when only forces that compress the balls into their slots and only preferred with relatively light loads when applied off axis or with torques. Furthermore, relative to rolling, only half the translational motion can be achieved. Implementations as disclosed herein are particularly useful in optics, microscopy, and small motion machines.

The implementations disclosed provide a method of forming kinematic slide bearing surfaces by applying force to a substantially sharp edged slot in a plate of a kinematic stage using hardened bearings constrained in a mating constraining plate in the kinematic stage and applying force to said kinematic stage until the sharp edge is transformed into a work hardened, self-aligned chamfered edge. This generally provides an overall method of kinematic positioning by fixing three contact elements in a constraining plate having, each contact element protruding from the constraining plate providing a lower engagement surface and an upper engagement surface. A first kinematic stage is formed with a first plate having at least two slots aligned for a first axis of translation, the at least two slots engaged by the lower engagement surface of two of the contact elements. A second kinematic stage is formed with a second plate having at least two slots aligned for a second axis of translation, the at least two slots engaged by the upper engagement surface of two of the contact elements. The first plate may then be translated relative to the constraining plate for motion relative to a first axis and the second plate may be translated relative to the constraining plate for motion relative to a second axis.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims. Within the specification and the claims the terms “comprising”, “incorporate”, “incorporates” or “incorporating”, “include”, “includes” or “including”, “has”, “have” or “having”, and “contain”, “contains” or “containing” are intended to be open recitations and additional or equivalent elements may be present. The term “substantially” as used within the specification and claims means that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide. As described herein and in the following claims, the terms “upper” and “lower” are relative to the implementations shown in the drawings and may be replaced with appropriate terms for other orientations.

What is claimed is:

1. A positioning stage comprising:
a constraining plate having three contact elements fixed therein, each contact element protruding from the constraining plate providing a lower engagement surface and an upper engagement surface;
a first plate having at least two slots aligned for a first single axis of translation, the at least two slots engaged by the lower engagement surface of two of the contact elements; and,
a second plate having at least two slots aligned for a second axis of translation, the at least two slots engaged by the upper engagement surface of two of the contact elements.

2. The positioning stage as defined in claim 1 wherein the first plate has three slots oriented for an x axis of translation, said three slots engaging the lower engagement surface of the three contact elements.

3. The positioning stage as defined in claim 2 wherein the second plate has three slots oriented for an y axis of translation, said three slots engaging the upper engagement surface of the three contact elements.

4. The positioning stage as defined in claim 3 wherein the contact elements are spherical balls having a hemispherical surface for each of the upper and lower engagement surfaces.

5. The positioning stage as defined in claim 2 wherein the second plate has three slots oriented for rotation about a rotation axis at equal radius from each of the engagement elements, said three slots engaging the upper engagement surface of the three contact elements.

6. The positioning stage as defined in claim 2 wherein the second plate has three slots oriented for a goniometric rotation about a center of rotation outside of a radial center of the engagement elements wherein a greater radii of curvature and lesser radii of curvature and of two outer slots and an inner slot, whereby the outer and inner slots are formed with a common center of curvature, the second plate is constrained to move along the inner slot over an inner engagement element on a lesser chord and the outer slots will move over the outer engagement elements along a greater chord, said outer and inner slots each engaging the upper engagement surface of a respective one of the three contact elements.

7. The position stage as defined in claim 4 wherein the spherical balls are ball bearings engaged in holes in the constraining plate.

8. The position stage as defined in claim 7 wherein the ball bearings are fixed in the holes by brazing, gluing, or press-fitting.

9. The position stage as defined in claim 1 wherein the engagement elements are formed from material having higher hardness than the first plate and second plate.

10. The positioning stage as defined in claim 9 wherein the engagement elements are ruby, sapphire or hardened steel balls and the first plate and second plate are half hardened steel plate.

11. The positioning stage as defined in claim 1 wherein the slots have a V cross section.

12. The positioning stage as defined in claim 1 further comprising cylinders parallel to and engaged in the slots, said engagement surfaces contacting the cylinders.

13. A method of forming kinematic slide bearing surfaces comprising:
applying force to a substantially sharp edged slot in a plate of a kinematic stage using hardened bearings constrained in a mating constraining plate in the kinematic stage and
applying force to said kinematic stage until the sharp edge is transformed into a work hardened, self-aligned chamfered edge.

14. A method for kinematic positioning comprising:
fixing three contact elements in a constraining plate having, each contact element protruding from the constraining plate providing a lower engagement surface and an upper engagement surface;
forming a first kinematic stage with a first plate having at least two slots aligned for a first axis of translation, the at least two slots engaged by the lower engagement surface of two of the contact elements; and,
forming a second kinematic stage with a second plate having at least two slots aligned for a second axis of translation, the at least two slots engaged by the upper engagement surface of two of the contact elements.

15. The method as defined in claim 13 further comprising translating the first plate relative to the constraining plate for motion relative to a first axis.

16. The method as defined in claim 14 further comprising translating the second plate relative to the constraining plate for motion relative to a second axis.

17. The method as defined in claim 14 wherein the first axis is an x axis and the second axis is an orthogonal y axis.

18. The method as defined in claim 14 wherein the first axis is an x axis and the second axis is a rotational axis at equal radius from each of the engagement elements.

19. The method as defined in claim 14 wherein the first axis is an x axis and the second axis is a center of rotation outside of a radial center of the engagement elements producing a goniometric rotation of the second plate.

20. The method as defined in claim 13 further comprising yielding and work hardening corners of the slots to a chamfered face thereby removing any effect of kinematic over constraint.

21. The method as defined in claim 13 wherein the first plate has three slots and the second plate has three slots and further comprising yielding and work hardening corners of the slots to a chamfered face.
